(19) United States
(12) Patent Application Publication
(10) Pub. No.: US 2004/0215634 A1
(43) Pub. Date: Oct. 28, 2004

(54) Methods and products for merging codes and notes into an integrated relational database

(75) Inventors: Todd D. Wakefield, Park City, UT (US); David L. Bean, West Bountiful, UT (US)

Correspondence Address: Parsons Behle & Latimer, Suite 1800, 201 South Main Street, Salt Lake City, UT, 84111, US

(73) Assignee: Attensity Corporation

(21) Appl. No.: 10/729,864

(22) Filed: Dec. 5, 2003

Related U.S. Application Data
(60) Provisional application No. 60/431,539, filed on Dec. 6, 2002.
(60) Provisional application No. 60/431,540, filed on Dec. 6, 2002.
(60) Provisional application No. 60/431,316, filed on Dec. 6, 2002.

(51) Int. Cl. G06F 7/00

(52) U.S. Cl. 707/100

(57) ABSTRACT

Disclosed herein are systems, methods and products for interpreting and structuring free text records utilizing extractions of several types including syntactic, role, thematic and domain extractions. Also disclosed herein are systems, methods and products for integrating interpretive extractions with structured data into unified structures that can be analyzed with, among other tools, data mining and data visualization tools.

### CROSS-REFERENCE TO RELATED APPLICATIONS

This application claims the benefit of U.S. Provisional Patent Application Serial No. 60/431,539, U.S. Provisional Patent Application Serial No. 60/431,540 and U.S. Provisional Patent Application Serial No. 60/431,316 all filed Dec. 6, 2002, each of which is hereby incorporated by reference in its entirety.

### BACKGROUND

This disclosure relates generally to computing systems functional to produce relationally structured data in the nature of relational facts from free text records, and more particularly to interpretive systems functional to integrate relationally structured data records with interpretive free text information, systems functional to extract relational facts from free text records or systems for relationally structuring interpreted free text records for the purposes of data mining and data visualization.

### BRIEF SUMMARY

Disclosed herein are systems, methods and products for interpreting and relationally structuring free text records utilizing extractions of several types including syntactic, role, thematic and domain extractions. Also disclosed herein are systems, methods and products for integrating interpretive relational fact extractions with structured data into unified structures that can be analyzed with, among other tools, data mining and data visualization tools. Detailed information on various example embodiments of the inventions are provided in the Detailed Description below.

### BRIEF DESCRIPTION OF THE DRAWINGS

FIG. 1 depicts an exemplary method of producing relational fact extractions from free text.

FIG. 2 depicts an exemplary method of integrating relationally structured data with unstructured data.

FIG. 3 depicts an interpretive process utilizing thematic caseframes. FIGS. 4a and 4b show an integrating process utilizing free text interpretation. FIGS. 5a, 5b and 5c depicts several computing system configurations for performing interpretive and/or integrating methods.

Reference will now be made in detail to some example embodiments.

### DETAILED DESCRIPTION

The discussion below speaks of relationally structured data (or sometimes simply structured data), which may be generally understood for present purposes to be data organized in a relational structure, according to a relational model of data, to facilitate processing by an automated program. That relational structuring enables lookup of data according to a set of rules, such that interpretation of the data is not necessary to locate it in a future processing step. Examples of relational structures of data are relational databases, tables, spreadsheet files, etc. Paper records may also contain structured data, if the location and format of that data follows a regular pattern. Thus paper records might be scanned, processed for characters through an OCR process, and structured data taken at known locations in each individual record.

In contrast, free text is expression in a humanly understood language that accords to rules of language, but does not necessarily accord to structural rules. Although systems and methods are herein disclosed specifically using free text examples in the English language in computer encoded form, any human language in any computer readable expression may be used, those expressions including but not restricted to ASCII, UTF8, pictographs, sound recordings and images of writings in any spoken, written, printed or gestured human language.

The discussion below also references caseframes of several types. Caseframes, generally speaking, are patterns that identify a particular linguistic construction and an element of that construction to be extracted. A syntactic caseframe, for example, may be applied to a parsed sentence to identify a clause that contains a subject and an active voice verb, and to extract the subject noun phrase. A syntactic caseframe often also uses lexical filters to constrain its identification process. For example, a user might want to extract the names of litigation plaintiffs in legal documents by creating a caseframe that extracts the subjects of a single active voice verb, sue. Other caseframe types may be fashioned, such as thematic role caseframes that apply their patterns, not to syntactic constructions, but thematic role relationships. More than one caseframe may apply to a sentence. If desired, a selection process may be utilized to reduce the number of caseframes that apply to a particular sentence, although under many circumstances that will not desirable nor necessary.

Many organizations today utilize computer systems to collect data about their business activities. This information sometimes concerns transactions, such as purchase orders, shipment records and monetary transactions. Information may concern other matters, such as telephone records and email communications. Some businesses keep detailed customer service records, recording information about incidents, which incidental information might include a customer identity, a product identity, a date, a problem code or linguistic problem description, a linguistic description of steps taken to resolve a problem, and in some cases a suggested solution. In the past it was undesirable to subject the linguistic elements of those records to study or analysis, due to the lack of automated tools and high labor cost of those activities. Rather, those records were often retained only for the purposes of investigation at a later time in the event that became necessary.

As computing equipment has become more powerful and less expensive, many organizations are now finding it within their means to perform analysis on the data collected in their business activities. Examples of those analytic processes include the trending of parts replacement by product model, the number of products sold in particular geographic regions, and the productivity of sales representatives by quarter. In those analytic processes, which are computer executed, data is used having a format highly structured and readily readable and interpretable by the computer, for example in tabular form. Because of this, much of the recent data collection activity has focused around capturing data in an easily structurable form, for example permitting a subject to select a number between 1 and 5 or selecting checkboxes indicating the subject's satisfaction or dissatisfaction of particular items.

Tabular or relationally structured data is highly amenable to computational analysis because it is suitable for use in relational databases, a widely accepted and efficient database model. Indeed, many businesses use a relational database management system (RDBMS) as the core of their data gathering procedures and information technology (IT) systems. The relational database model has worked well for business analysis because it can encode facts and events (as well as their attributes) in a relationally structured format, which facts, events and attributes are often the elements that are to be counted, aggregated, and otherwise statistically manipulated to gain insights into business processes. For example, consider an inventory management system that tracks what products are sold by a chain of grocery stores. A customer buys two loaves of bread, a bunch of bananas, and a jar of peanut butter. The inventory management system might record these transactions as three purchase events, each event having the attributes of the item type that was purchased, the price of each item, the quantity of items purchased, and the store location. These events and corresponding attributes might be recorded in a tabular structure in which each row (or tuple) represents an event, and each column represents an attribute:

| Item | Price | Quantity | Store Location |
|---|---|---|---|
| Bread | $2.87 | 2 | Chicago |
| Bananas | $1.56 | 1 | Chicago |
| Peanut Butter | $2.13 | 1 | Chicago |

A table such as this populated with purchase events from all the stores in a chain would produce a very large table, with perhaps many millions of tuples. While humans would have difficulty interpreting and finding trends in such a large quantity of raw data, a system including an RDBMS and optionally an analysis tool may assist such an effort to the point that it becomes a managable task.

For example, if an RDBMS were used accepting structured query language (hereinafter “SQL”) commands, a command such as the following might be used to find the average price of items sold in the Chicago store:

SELECT AVG (PRICE)

FROM PURCHASE_TABLE

WHERE STORE_LOCATION=CHICAGO

The use of an RDBMS also would permit the linking of rows of one table to the rows on another table through a common column. In the example above, a user could link the purchase events table with an employee salary table by linking on the store location column. This would allow the comparison of the average price of purchased items to the total salaries paid at each store location. The ability to relationally structure data as in rows and columns, link tables through column values, and perform statistical operations such as average, sum, and counting makes the relational model a powerful and desirable data analysis platform.

Relationally structured data, however, may only represent a portion of the data collected by an organization. The amount of unstructured data available may often exceed the amount of structured data. That unstructured data often takes the form of natural language or free text, which might be small collections of text records, sentences or entire documents, which convey information in a manner that cannot readily structured into rows or columns by an RDBMS. The usual RDBMS operations are therefore most likely powerless to extract, query, sort or otherwise usefully manipulate the information contained in that free text.

Some RDBMSs have the ability to store textual or other non-processable content as a singular chunk of data, known as a BLOB (binary large object). Although that data is stored in a relational database, the system treats it as an unprocessable miscellaneous data type. A column of a table can be defined to contain BLOBs, which permits free text to be stored in that table. In the past this approach has been helpful only to provide a storage mehanism for unstructured data, and did not facilitate any level of processing or analysis because the relational database queries are not sophisticated enough to process that data. Because of this, the processing of data captured in unstructured free text (as character strings, BLOBs or otherwise) contained in a relational database for business analysis is unfamiliar in the art.

Many businesses today collect textual data even through it cannot be automatically analyzed. This data is collected in the event that a historical record of the business activity with greater richness than is afforded by coding mechanisms will be helpful, for example to provide a record of contact with a particular customer. An applicance manufacturer, for example, may maintain a call center so customers can call for assistance in using its products, reporting product failures, or requesting service. When a customer calls in, a manufacturer's agent takes notes during the call, so if that same customer calls in at a later time, a different agent will have the customer's history available.

The amount of information stored in textual form by organizations today is enormous, and continues to grow. By some accounts, the data of a typical oranization is 90 percent textual in nature. The value of text-based data is particularly high in environments that capture input external to an organization, e.g. customer interactions through call centers and warranty records through dealer service centers.

Businesses may perform a lesser level of analysis of free text data, such as might be captured in the call center example above, through a manual analysis procedure. In that activity a group of analysts read through representative samples of call center records looking for trends and outliers in the customer interaction information collection. The analysts may find facts, events or attributes that could be stored in a relational table if they could be extracted from that text and transformed into structured data tuples.

In the grocery store example above, the purchasing event information was coded into relationally structured rows and columns of a table. That same information could also be stored in natural language, such as “John bought two loaves of bread for $2.87 each in the Chicago store.” Some business circumstances or practices may dictate that mainly natural language records be kept, as in the customer service center example above. In other circumstances it will be desirable to keep both structured data and natural language records, at least some of those records being related by event or other relation. In order to extract information from natural language records, an interpretation step can be performed to translate that information to a form suitable for analysis. That translated information may then be combined with structured data sources, which is an integration or joining step, permitting analysis over the enlarged set of relationally structured data.

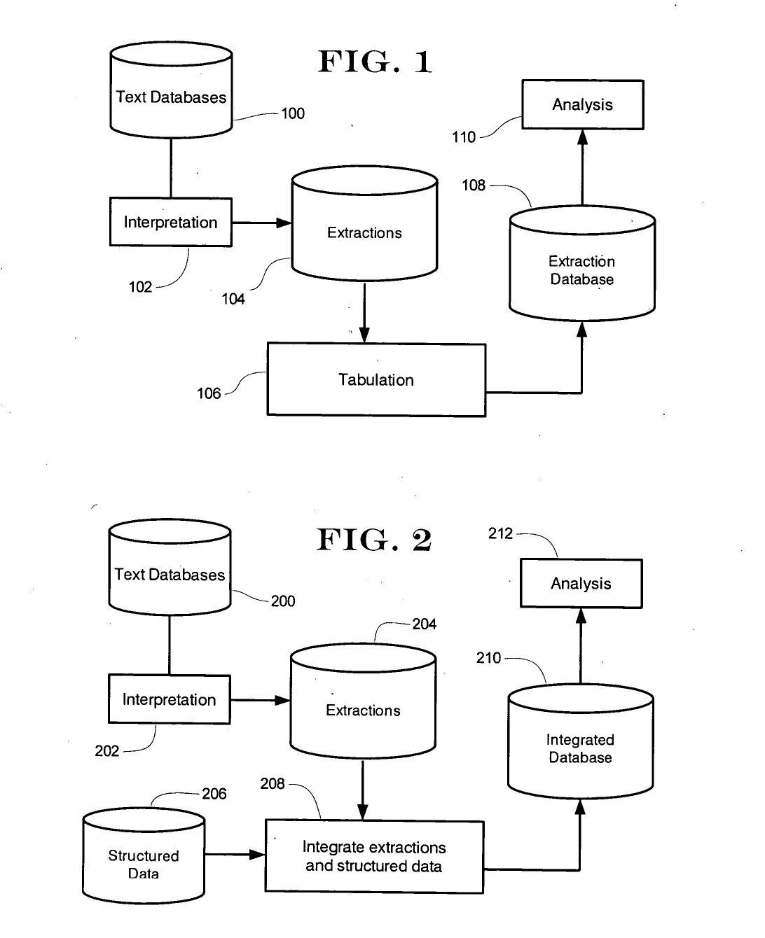

One example method of producing extractions from free text for analysis is shown in FIG. 1. Through activities of a business or other organizational entity, a quantity of free text is collected in a database 100. Database 100 contains entries that include free text data, which is not readily processable without a natural language interpretation step. An interpretation step 102 is performed, in which the free text data of database 100 is subjected to an interpretive operation. Extractions 104 are produced, which is data construed by the interpreter according to a set of parsing and other interpretive rules. Extractions 104 may be stored, for example to disk, or may exist in a shorter-term memory as intermediate data for the next step. In one exemplary method, interpretation 102 includes the application of syntactic caseframes. In another method, interpretation 102 includes the production of role/relationship extractions. Extractions 104 are then tabulated 106, or organized in a tabular format for ease of processing, some examples being provided below. The tabulated results are then stored to a database 108, which may serve as input for analysis 110.

Another exemplary method of integrating mixed data, structured and unstructured, will now be explained referring to FIG. 2. In this example, a text database is provided containing free text entries. Through like business activities, structured data is collected in database 206. Database 206 contains entries that include structured data, that is data that does not require a natural language parsing step to interpret, for example serial numbers, names, dates, numbers, executable scripts and values in relationship to one another. Now databases 200 and 206 (and 100 above) may be maintained in a relational database management system. (RDBMS), however databases may take any form accessible by a computer, for example flat files, spreadsheet formats, XML, file-based database structures or any other format commonly used or otherwise. Although databases 200 and 206 are shown as separate entities for the purposes of discussion, these databases need not be separate. In one example system, databases 200 and 206 are one in the same, with the free text entries of database 200 being included in the tuples of structured data 206, in the form of strings or binary embedded objects. In another exemplary system, both the free text and structured data are stored in a common format, for example XML entries specifying a tuple of both free text and structured data. Numerous other formats may be used as desired. Interpretation 202 produces extractions 204, as in the method of FIG. 1.

Now the free text information contained in text database 200 is provided with references or other relational information, explicit or implicit, that permits that free text information to be related to one or more entries of structured data 206. In a second step 208, the extractions 204 are joined with the structured data 206, forming a more complete and integrated database 210. Now although database 210 is shown as a separate database from the data sources, integrated or joined data may also be returned to the original structured data 206, for example in additional columns. Database 210 may then be used as input for analysis activities 212, examples of which are discussed below.

In the diverse practices of data collection, there are many circumstances where structured data is collected in addition to some amount of unstructured free text. For example, a business may define codes or keyed phrases that correspond to a particular problem, circumstance or situation. In defining those codes or phrases, a certain amount of prediction and/or foresight is used to generate a set of likely useful codes. For example, a software program might utilize a set of codes and phrases like “Error 45: disk full!”. That software program will inherently contain a set of error codes, which can be used in the data collection process, as defined by the developers according to their understanding of what might go wrong when the software is put into use.

For even the most simple of products, the designers will have a limited understanding of how those products will perform outside of the development or test environment. Certain problems, thought to occur rarely, might be more frequent and more important to correct. Other problems may unexpectedly appear after a product is released, or after the codes have been set. Additionally, many products go through stages, with many product versions, manufacturing facilities, distribution channels, and markets. As the product enters a new stage, new situations or problems may be encountered for which codes are not defined.

Thus in collecting data, a person may encounter a situation that does not have a matching code. That person may then capture the situational details in notation, for example using a “miscellaneous” code and entering some free text into a notes field. Those notational entries, being unstructured, are not directly processable by an RDBMS or analytical processing program without a natural language interpretation step. That notational entry information may therefore be difficult to analyze, in prior systems without human analysis.

Some of the disclosed systems provide for the extraction of information from notational information, which information may be useful in many business situations alone or combined with structured or coded information. Customer service centers presently collect a large amount of data and notational information, organized by customer, for example. Many product manufacturers track individual products by a serial number, which are entered on a trouble ticket should the item be returned for repair. On such a trouble ticket may be information entered by a technician, indicating the diagnosis and corrective action taken. Likewise, airlines collect a large amount of information in their operations, for example aircraft maintenance records and individual passenger routing data. An airline might want to make early identification of uncategorized problems, for example the wear of critical moving parts. An airline might also collect passengers' feedback about their experience, which may contain free text, and correlate that feedback with routes, aircraft models, ticket centers or personnel.

Likewise an automobile manufacturer may collect information as cars under warranty are brought in for service, to identify common problems and solutions across the market. Much of the information reflecting symptoms, behaviors and the customer's experience may be textual in nature, as a set of codes for automobile repair would be unmanageably large. A telecommunications, entertainment or utility company might also collect a large quantity of textual information from service personnel. Sales and retail organizations may also benefit from the use of disclosed systems through the tracking of customer comments which, after interpretation, can be correlated back to particular sales personnel.

Disclosed systems and methods might also be used by law enforcement organizations, for example as new laws are enforced. Traffic citations are often printed in a book, with a code for each particular traffic infraction category. An enforcement organization may collect textual comments not representable in the codes, and take measures to enforce laws repeatedly violated (i.e. driver stopped repeatedly for children not restrained.) Likewise, insurance companies may benefit from the disclosed systems and methods. Those organizations collect a large quantity of textual information, i.e. claims information, diagnoses, appraisals, adjustments, etc. That information, if analyzed, could reveal patterns in the behavior of insured individuals, as well as adjustors, administrators and representatives. That analysis might be useful to find abuses of those persons, as well as potentially detecting fraudulent claims and adjustments. Likewise, analysis of textual data may lead to detection of other forms of abuse, such as fraudulent disbursements to employees. Indeed, the disclosed systems and methods may find application in a very large number of business activities and circumstances.

In some of the disclosed methods, integrated records and databases are produced. An integrated record is the combination of data from a structured database record and the extracted relational fact data from the corresponding free text interpretation. An integrated record may be combined in the same data structure, for example a row of a table, or may exist in separate files, records or other structures, although for an integrated record a relation is maintained between the data from the structured records and the interpreted data.

An interpretation of free text may be advantageously performed in many ways, several of which will be disclosed presently. In one interpretive method, syntactic caseframes are utilized to generate syntactic extractions. In another interpretive method, thematic roles are identified in linguistic structures, those roles then being used provide extractions corresponding to attribute value pairs. In a further related interpretive method, thematic caseframes are applied to reduce the number of unique or distinct attribute extractions produced. Another related interpretive method further assigns domain roles to thematic roles to produce relational fact extractions.

The interpretive methods disclosed herein are performed first with a linguistic parsing step. In that linguistic parsing step a structure is created containing the grammatical parts, and in some cases the roles, within particular processed text records. The structure may take the structure of a linguistic parse tree, although other structures may be used. A parsing step may produce a structure containing words or phrases corresponding to nouns, verbs, prepositions, adverbs, adjectives, or other grammatical parts of sentences. For the purposes of discussion the following simple sentence is put forth:

(1) John gave some bananas to Jane.

In sentence (1), a parser might produce the following output:

```
CLAUSE:
    NP
        John
    VP
        gave
    NP
        ADJ
              some
        bananas
    PP
        PREP
              to
        NP
              Jane
```

Although that output is sufficient for syntactic caseframe application, it contains very minimal interpretive information. A more sophisticated linguistic parser might produce output containing some minimal interpretive information:

```
CLAUSE:
    NP (SUBJ)
        John [noun, singular, male]
    VP (ACTIVE_VOICE)
        gave [verb, past tense]
    NP (DOBJ)
        some [quantifier]
        bananas [noun, plural]
    PP
        to (preposition)
        NP
            Jane [noun, singular, feminine]
```

That output not only shows the parts-of-speech for each word of the sentence, but also the voice of the verb (active vs. passive), some attributes of the subjects of the sentence and the role assignments of subject and direct object. A wide range of linguistic parser types exist and may be used to provide varying degrees of complexity and output information. Some parsers, for example, may not assign subject and direct object syntactic roles, others may perform deeper syntactic analysis, while still others may infer linguistic structure through pattern recognition techniques and application of rule sets. Linguistic parsers providing syntactic role information are desirable to provide input into the next stage of interpretation, the identification of thematic roles.

Thematic roles are generally identified after the linguistic parsing stage, as the syntactic roles may be marked and available for extraction. The subject, direct object, indirect objects, objects of prepositions, etc. will be identified. The use of syntactic roles for extraction may produce a wide range of semantically similar pieces of text that have very different syntactic roles. For example, the following sentences convey the same information as sentence (1), but have very different linguistic parse outputs:

(2) Jane was given some bananas by John.

(3) John gave Jane some bananas.

(4) Some bananas were given to Jane by John.

To avoid this ambiguity, a linguistic parse product may be further evaluated to determine what role each participant in the action of the text record plays, i.e. to assign thematic roles. The following table provides a partial set of thematic roles that may be useful for the assignment:

| Role | Description |
|---|---|
| Actor | A person or thing performing an action. |
| Object | A person or thing that is the object an action. |
| Recipient | A person or thing receiving the object of an |
| | action. |
| Experiencer | A person or thing that experiences an action. |
| Instrument | A person or thing used to perform an action. |
| Location | The place an action takes place |
| Time | The time of an action |

For each of sentences (1) to (4), three thematic roles are consistent. John is the actor, Jane is the recipient, and the object is some bananas.

The use of thematic role assignment can simplify the form of the information contained in text records by reducing or removing certain grammatical information, which has the effect of removing the corresponding categories for each grammatical permutation. Fewer text record categorizations are thereby produced in the process of interpretation, which simplifies the application of caseframes, which will be discussed presently. For sentence (1), an interpretive intermediate structure having role assignment information added might take the form of:

```
CLAUSE:
    NP (SUBJ) [THEMATIC ROLE: ACTOR]
        John [noun, singular, male]
    VP (ACTIVE_VOICE)
        gave [verb, past tense]
    NP (DOBJ) [THEMATIC ROLE: OBJECT]
        some [quantifier]
        bananas [noun, plural]
    PP
        to (preposition)
        NP [THEMATIC ROLE: RECIPIENT]
            Jane [noun, singular, feminine]
```

A thematic role extraction need not include more than the thematic role information, although it may be desirable to include additional information to provide clues to later stages of interpretation. Thematic role information may be useful in analysis activities, and may be the output of the interpretive step if desired.

After parsing and the assignment of thematic roles, thematic caseframes may be applied to identify elements of text records that should be extracted. The application may provide identification of particular thematic roles or actions for pieces of text and also filter the produced extractions. For example, a thematic caseframe for identifying acts of giving might be represented by the following:

| | |
|---|---|
| ACTION: giving | |
| ACTOR - | Domain Role: Giver - Filter: Human |
| RECTPIENT - | Domain Role: Taker - Filter: Human |
| OBJECT - | Domain Role: Exchangable item |

In this example caseframe, the criteria are (1) that the actor be a human, (2) that the recipient also be human and (3) that the object be exchangeable. This caseframe would be applied whenever a role extraction is found in connection with a giving event, a giving event being defined to be an action focused around forms of the verb “give” and optionally in combination with other verb forms of synonyms.

The interpretation might consider only the specified roles, or might consider the presence or absence of unspecified roles. For example, the interpretation might consider other unspecified role criteria to be wildcards, which would indicate that the above example thematic caseframe would match language having any locations, times, or other roles, or match sentences that do not state corresponding roles. The caseframe might also require only the presence or absence of a role, such as the time, for purposes of excluding sentence fragments too incomplete or too specific for the purposes of a particular analysis activity.

Under many circumstances, a dictionary may be used containing words or phrases having relations to the attributes under test. For example, a dictionary might have an entry for “bananas” indicating that this item is exchangeable. The information in a single sentence, however, may not be sufficient to determine whether a particular role meets the criteria of a thematic caseframe. For example, sentence (1) gives the names of the actor (John) and the recipient (Jane), but does not identify what species John and Jane belong to. John and Jane might be presumed to be human in the absence of further information, however the possibility that John and Jane are Chimpanzees cannot be excluded using only the information contained in sentence (1). More advanced interpretation methods may therefore look to other clauses or sentences in the free text record for the requisite information, for example looking to clauses or sentences within the same paragraph or overall text record. The interpretation may also look to other sources of information, if they are available as input, such as separate references, books, articles, etc. if they can be identified as containing relatable information to the text under interpretation. If interpretation of surrounding clauses, sentences, paragraphs or other related material is pending, the application of a thematic caseframe may be deferred for the other material to be processed. If desired, application of caseframes may progress in several passes, processing “easy” pieces of text first and progressively working toward interpretation of more ambiguous ones.

Text records may contain multiple themes and thematic roles. For example, in the sentence “John, having received payment, gave Jane some bananas” contains 2 roles. The first role concerns that of giver in the action of John giving Jane the bananas. The second role concerns that of receiver in the action of John receiving payment. An interpretive process need not restrict the number of theme extractions to one per clause, sentence or record, although that may be desirable under some circumstances to keep the number of roles to a more manageable set.

The output of interpretation may again be roles, which may further be filtered through the application of thematic caseframes. In other interpretive methods, domain roles may be assigned. A domain role carries information of greater specificity than that of the role extraction. In the “giving” caseframe example above, the actor might be identified as a “giver”, the recipient as a “taker” and the object as the “exchanged item.” The assignment of these domain identifiers is useful in analysis to provide more information and more accurate categorization. For example, it may be desired to identify all items of exchange in a body of free text.

Many domains may occur for a given verb form or verb form category. The following table outlines several domains associated with the root verb “hit”.

| Exemplary sentence fragment | Domain |
|---|---|
| Joe hit the wall | Striking |
| Joe hit Bob for next month's sales forecast | Request |
| Joe hit Bob with the news | Communication |
| Joe hit the books | Study |
| Joe hit the baseball | Sports |
| Joe hit a new sales record | Achievement |
| Joe hit the blackjack player | Card games |
| Joe hit on the sexy blonde | Romance |
| Joe hit it off at the party | Social activity |

A single generic thematic caseframe might therefore be applicable to several domains. In some circumstances, the nature of the information in a database will dictate which domains are appropriate to consider. In other circumstances, the interpretive process will select a domain, that selection utilizing information contained within a text record under interpretation or other information contained in the surrounding text or other text of the database. Thematic caseframes may be made more specific to identify a domain type for a piece of text under consideration, by which information of unimportant domains may be eliminated and information of interesting domains may be identified and output in extractions.

Thus the output of the interpretive step may include domain specific or domain filtered information. Such output may generally be referred to as relational fact extractions, or merely relational extractions. Relational extractions may be especially helpful due to the relatively compact information contained in those extractions, which facilitates the storage of relational extractions in database tables and thereby comparisons and analysis on the data. Relational extractions may also improve the ability for humans to interact with the analysis and the interpretation of that analysis, by utilizing natural language terms rather than expressions related to a parsing process.

As explained above, the interpretive process may alternatively or additionally produce relational extractions through the use of syntactic caseframes, especially if thematic role assignment is not performed. A syntactic caseframe may be further defined to produce relational information. For example, a corresponding syntactic caseframe to the “giving” thematic caseframe above might be represented by:

| | |
|---|---|
| ACTION: giving | |
| SUBJECT - | Domain role: Giver - Filter: Human |
| PREP-OBJ:TO - | Domain role: Taker - Filter: human |
| DIRECT OBJECT - | Domain role: Exchanged Item |

Note that this syntactic caseframe will apply to example sentences (1) and (2), but not to (3) and (4). Because syntactic caseframes test parts of sentences or sentence fragments according to specific grammatical rules, for example testing for specific verb forms and specific arrangements of grammatical forms (nouns, verbs, etc.) in a piece of text, a particular syntactic caseframe will not generally match to more than one verb and arrangement combination. The use, therefore, of syntactic caseframes as a set, one per each verb/arrangement combination, may be advantageous. Because of the larger number of caseframes that can be required and the grammatical complexity therein, the use of thematic caseframes may be used in many circumstances.

Regardless of the type of interpretive process used, the result will be a set of relational extractions, or record of extraction, each extraction can reference the text record from which it was extracted if desired. The inclusion of those references makes it possible to drill down to the specific locations in the records (or other sources) containing the text from analytic views upon receipt of a user indication from a visual representation of the integrated data, displaying the original free text. The record of extraction may be output in a format viewable and/or editable by a human, using, for example, the XML format, or it might be output to a new database or retained as intermediate data in memory. The record of extraction might also be saved to a local disk, stored to an intermediate database for later use, or transmitted as a data stream to another process or computing system.

Under many circumstances it will be desirable to coalesce the role and/or relational data in the record of extraction to reduce the number therein and simplify later analysis. For example, the extractions may contain unwanted lexical variation. The sentences “Windows failed . . . ”, “Win95 failed . . . ”, “The operating system failed . . . ” and “Windows95 failed . . . ” might all reference the same operating system. In the processing steps these individual expressions might be counted independently. Terms such as these can be unified to a common symbol, so an analytic process may identify those terms as a group for the purposes of finding trends, associations, correlations and other data features. A collection of logical rules may be advantageously utilized to perform this function, replacing the extracted terms so that the final database will contain consistent results. Those rules may match an expressed attribute on the bases of an exact string match, a regular expression match, or semantic class match.

In another exemplary method, events may be coalesced. In the extractional record, relationships or actions may also have undesirable variability. For example, the pieces of text “Windows failed . . . ”, “Windows crashed . . . ”, “Windows blew up . . . ” and “Windows did not operate correctly . . . ” all contain a similar event, which is the malfunction of a Windows operating system. Each of these variations might be extracted from slightly different extraction mechanisms, which might be different thematic caseframes. A method may provide recognition that expressions are semantically similar and reduce those to a similar role. That method may utilize a taxonomy of relationships or actions, expressing them in a number of ways. In the above example, the following taxonomy might be helpful:

Engineering issues

Product failures

Explicit failures (failed, did not operate, stopped working, etc.)

Destructions (blew up, fell into pieces, etc.)

Intermittent issues . . .

Marketing issues

Feature requests

Nice-to-have feature requests

Must-have feature requests

Using that taxonomy, “the widget failed” might be considered an “Explicit failure”, which also makes that event a “Product failure” and an “Engineering issue”. The application of that and other taxonomies permits the analysis of relational facts at several levels of aggregation and abstraction.

In practice, the application of such a taxonomy may occur as a part of the relational fact extraction system, on the product database or other structure, or both. For example, minor transformations may be made at the linguistic level, i.e. recognizing “failed” and “did not operate” as “Explicit failures” during the free text interpretation process, reducing the processing needed on the back end. Transformations may also be performed during analysis activities, for which a table of parent-child relationships may be paired with the record of extraction for delivery to the analytical processing system.

In transforming an extracted set of relational facts into a table, an analytic system normally has a set of attribute types that match the attribute types that are expected to be in the data extracted from any text. Such a table might have a column for each of those expected attributes. For example, if a system were tuned to extract plaintiffs, defendants and jurisdictions of lawsuits, a litigation table might be constructed with one column for each attribute representing each one of those litigation roles.

In a first approach, a review is conducted over the entirety of the roles and relationships in a data set, perhaps after combining like relational facts. During that review, a library is built with the relationships encountered and the roles attendant to each relationship. This approach has the advantage that a library can be constructed that will exactly match the extracted data. The process of the review, however, may consume a considerable amount of time. Additionally, if a destination database already exists, such as would be the case for systems that operate periodically, additional housecleaning and/or maintenance may be necessary if the table structures change as a result of new extractions.

In an alternative approach, a standard schema for the destination database may be constructed. In that approach thematic caseframes are used only if those caseframes generate relational fact extractions that map into that schema. Regardless of what approach is used, the goal is to provide a destination database for analytical use (sometimes referred to as a “data warehouse” or “data mart”) with appropriate table structures and/or definitions for data importing. Those table structures/definitions may then be supplied in the output data provided for further processing or analysis steps.

In one example method, the role and/or relationship information is produced in a tabular format. In one of those formats, relationships are mapped to relational fact types in a table of the same name. Within those tables, roles are mapped to attributes, i.e. to columns of the same name as their domain name in the event table. Thus in that format, relationships equate to relational fact types which are stored as tables, and roles equate to attributes which are stored as columns in the tables.

The interpretive process eventually produces output, which output might be in several forms. One form, as mentioned above, is one or more files in which relational structure is encoded into an XML format, which is useful where a human might review and/or edit the output. Other formats may be used, such as character separated values (CSV) (the character can be any desired character such as a comma), or separations using other characters. Likewise, spreadsheet application files may be used, as these are readily importable into programs for editing and processing. Other file-based database structures may be used, such as dBase formatted files and many others.

The output of the interpretive process may be coupled to the input of a relational database management system (RDBMS). The use of relational database management systems will be advantageous in many circumstances, as these are typically tuned for fast searching and sorting, and are otherwise efficient. If a destination RDMBS (a/k/a data warehouse or data mart) is not accessible to an interpretive process, a database may be saved and transported by physical media or over a network to the RDBMS system. Many RDBMSs include file database import utilities for a number of formats; one of those formats may be advantageously used in the output as desired.

The output of the interpretive process may be sufficient, from an analytic point of view, to use independently of any pre-existing structured data. Under some circumstances, however, combining pre-existing relationally structured data with the output of the extraction process provides a more complete or useful data set for an analytic processing system. In one method, an interpretive process output is produced without regard to any pre-existing structured data. That production does not necessarily complete to the writing of a file or the storage in a database, but can exist as an intermediate format, for example in memory. The pre-existing structured data is then integrated into the process output, producing a new database. In another method, the structured data is iterated over, considering each piece of that data. Any free text is located for that structured data and interpreted, and the resulting attribute/value information re-integrated into the original pre-existing structured data. In a third method, two or more databases are produced linked by a common identifier, for example a report or incident number.

Many of the interpretive steps disclosed above are susceptible to optimization through parallel processing. More particularly, the steps of parsing, applying syntactic caseframes and in some cases the application of thematic caseframes will not require information beyond that contained in a single sentence or sentence fragment. In those cases the interpretive work may, therefore, be divided into smaller processing “chunks” which may be executed by several processes on a single computer or separate computers. In those circumstances, especially where large databases and/or large text bodies are involved, parallel processing may be desirable.

Likewise, the processing for pieces of text, roles and relations need not be ordered in any particular way, except for steps dependent on other steps as may be. The ordering, therefore, might be according to the order of the source material, by data categorization, by an estimated time to completion or any number of other orders.

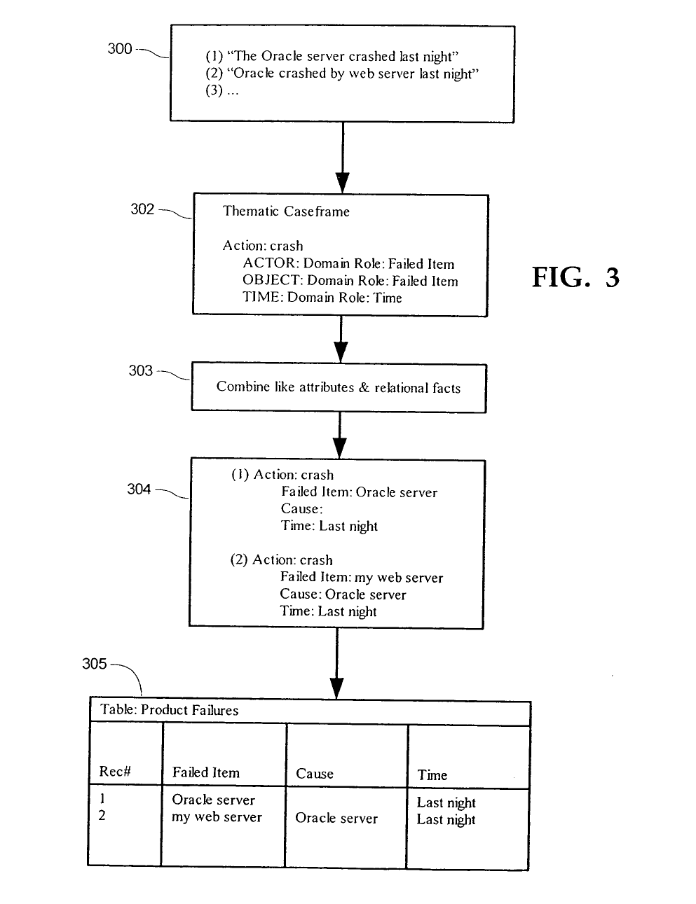

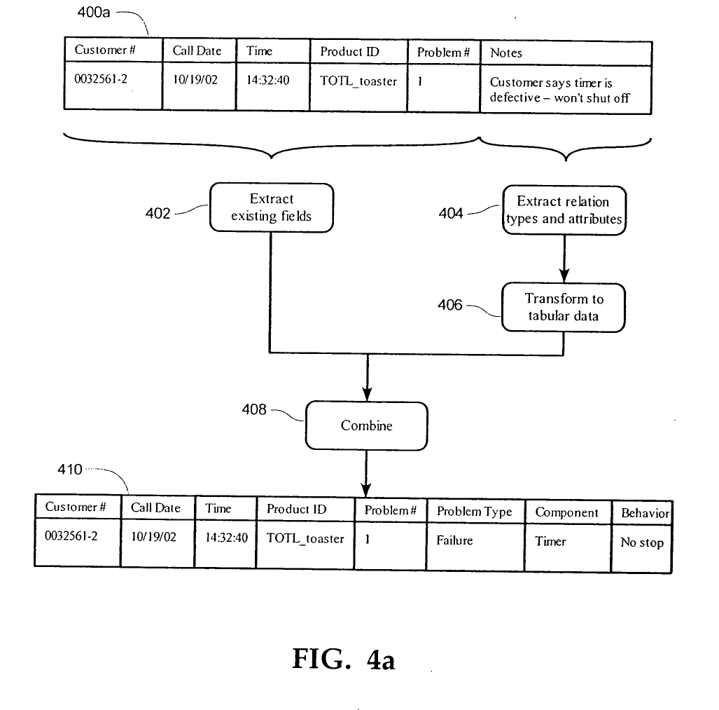

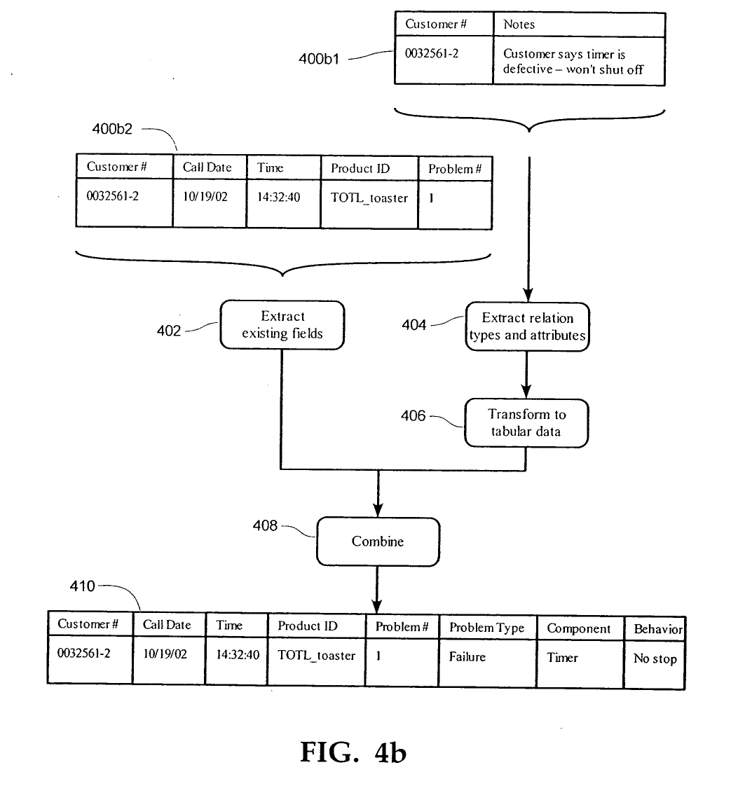

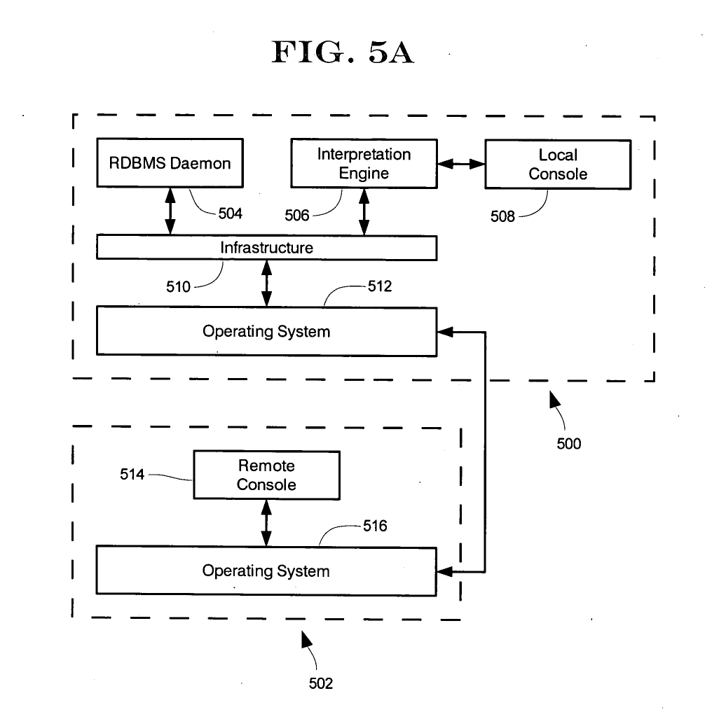

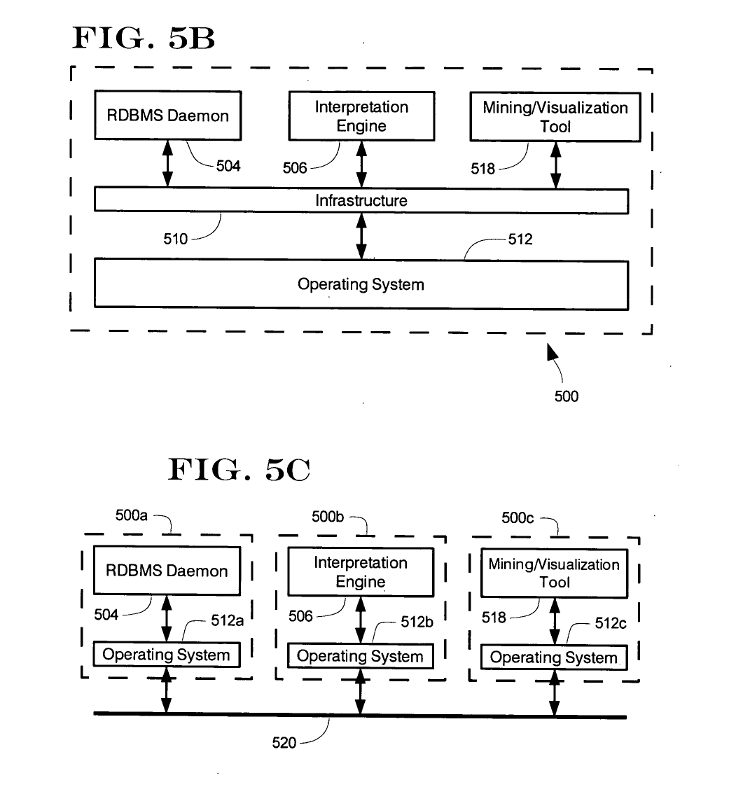

An interpretive process is conceptually illustrated in FIG. 3. A group of free text elements are associated with a number of records, in this case extending from the identifier “(1)”. Those elements are subjected to a linguistic parsing operation, after which thematic caseframes 302 are applied, one thematic caseframe for the action of “crash” being shown. In that caseframe, roles are passed which have an actor of a failed item, an object of a failed item, and a specified time. The next step is to combine like attributes and relational fact types 303. In the example of FIG. 3, the two sentences share a common relational fact—a product failure event. Relations 304 are then produced for each sentence, maintaining the references “(1)” and “(2)” back to the original identification. A table 305 is then produced having several columns including the columns of identifier (“Rec #”) and the several roles of “failed item”, “cause” and “time”. Table 305 contains a row for each interpreted record for which a thematic caseframe matched, which in this case includes the records of (“1”) and (“2”) as well as any other matching records, not shown.

Another interpretive process is conceptually illustrated in FIG. 4a. In this example, both the textual data (the Notes field) and the structured data exist in the fields of the same database table 400a. A user may identify which fields of the source table are text, which fields are structured data, and which fields should be ignored (no fields are ignored in this example). The contents of the text fields are processed 404, extracting relation types and attributes contained therein. The relation types and attributes of those extractions are then placed in tabular form 406. Existing and selected structured data fields are also extracted from the source table 402, but no interpretation is performed thereon. Rather the information in these fields may be passed on in original form to be combined 408 with the tabular data produced in 406. The combination of the two data sets may now be created in a singular table 410 that includes columns for all incoming fields. In this example, the incoming fields are customer number, call date, time, product ID, problem number, problem type, component, and behavior, the latter three coming from the textual notes field in the original table.

FIG. 4b shows a similar process to that of FIG. 4a, with the difference that the original data is located in separate tables, 400b1 and 400b2, linked through a common key field, the customer number. A user may still identify which fields are text, which fields are structured data, and which fields should be ignored. In this example, the user also now identifies more than one table for these criteria and, if necessary, which are the linking key fields.

Now although FIGS. 4a and 4b show a process producing a single integrated record, the combination process might be set to produce either a single table that includes columns for each incoming field, or alternatively any number of tables linked by key fields. Often, this latter approach makes more sense. Consider a call center that is to track a number of relation types (corresponding to business events of concern) within notes fields, e.g. customer dissatisfaction events, product failures and safety incidents. In the examples of FIG. 4a and 4b, a user might elect to create four destination tables: one that contains the existing tabular fields and one for each of the three notes-generated event types. These four tables might be linked via a set of common key fields, e.g. the customer ID number and a call ID number. The useage of common keyed fields is particularly useful where more than one integrated record is produced per structured record, which permits a many-to-one mapping between extracted information and a structured record.

The product of a free text interpretive process may be used to perform several informational activities. Relational facts extracted from free text may be used as input into a data mining operation, which is in general the processing of data to locate information, relations or facts of interest that are difficult to perceive in the raw data. For example, data mining might be used to locate trends or correlations in a set of data. Those trends, once identified, may be helpful in molding business practices to improve profitability, customer service and other benefits. The output of a data mining operation can take many forms, from simple statistical data to processed data in easy-to-read and understand formats. A data mining operation may also identify correlations that appear strong, providing further help in understanding the data.

Another informational activity is data visualization. In this activity, a data set is processed to form visual renderings of that data. Those renderings might be charts, graphs, maps, data plots, and many other visual representations of data. The data rendered might be collected data, or data processed, for example, through a statistical engine or a data mining engine. It is becoming more and more common to find visualization of real-time or near-real time data in business circumstances, providing up-to-date information on various business activities, such as units produced, telephone calls taken, network status, etc. Those visualizations may permit persons unskilled in analytical or statistical activities, as is the case for many managerial and executive persons, to understand and find meaning in the data. The use of data extracted from free text sources can add, in many circumstances, a significant amount of data available to be viewed not before available.

There are several products available suitable for performing data mining and data visualization. A first product set is the “S-Plus Analytic Server 2.0” (visualization tool) and the “Insightful Miner” (data mining tool) available from Insightful Corporation of Seattle, Wash., which maintains a website at http://www.insightful.com. A second data mining/visualization product set is available in “The Alterian Suite” available from Alterian Inc. of Chicago, Ill., which maintains a website at http:/Hwww.alterian.com. These products are presented as examples of data mining and data visualization tools; many others may be used in disclosed systems and may be included as desirable.

The methods disclosed herein may be practiced using many configurations, a few of which are conceptually shown in FIGS. 5a, 5b and 6. FIG. 5a shows an integral system that might be used, for example, by a small company with a limited amount of input data to produce tabular data extracted from free text and optionally integrated with other structured data. That system includes a computer, workstation or server 500 having loaded thereon an operating system 512. Computer 500 includes infrastructure 510 for database communication between processors, which might be a part of operating system 512 or as an add-on component. Infrastructure 510 might include Open Database Connectivity (ODBC) linkage, Java Database Connectivity (JDBC) linkage, TCP/IP socket and network layers, as well as regular file system support. In this example, relational database support is provided by an RDBMS daemon 504, which might be any relational database server program such as Oracle, MySQL, PostgreSQL, or any number of other RDBMS programs. An interpretation engine 506 is provided to perform activities related to the interpretation and/or integration of free text data as disclosed in methods herein, and accesses databases through infrastructure 510 to either relational databases through daemon 504 or to files through file system support. Likewise, interpretation engine 506 may deposit a product database to either a database managed by daemon 504 or to a file system managed by infrastructure 510. Local console 508 may optionally be provided to control or monitor the activities of interpretation engine 506. Alternatively, a remote console 514 utilizing the operating system 516 of a separate computer 502 may control or monitor the interpretation engine 506 through a network from a location other than the local console. Now an interpretation engine does not necessarily have to have a console; it may be commanded through scripts or many other input means such as speech or handwriting.

FIG. 5b conceptually shows a similar system to that of FIG. 5a, with the addition that a mining and/or visualization tool is installed to computer 500. Tool 518 access the product database of interpretation engine either on a file system managed by the local infrastructure 510 or daemon 504. Tool 518 efficiently performs the processing workload of the actions performed, being near the data to analyze or visualize. Tool 518 provides results to a user through many possible ways, e.g. depositing the results to a file system, display the results on a local console, or communicating the results to another computer over a network for display, storage or rendering.

FIG. 5c conceptually shows another similar system to that of FIG. 5c, but rather than using a single computer, several are used. Each of computers those computers 500a, 500b and 500c includes an operating system, respectively 512a, 512b and 512c. The infrastructure of earlier figures is not shown in this example for simplicity. The system of FIG. 5c includes an interpretation engine 506, an RDBMS daemon 504 and a mining or visualization tool 518 each located to separate computers. Communication is provided through a network 520 which links computers 500a, 500b and 500c.

This system model is especially helpful where the interpretation engine is located apart from either the RDBMS or the mining/visualization tool, as might occur if the interpretation engine 506 is provided as a service to business entities having either an RDMBS server or mining visualization tool. The service model may provide certain advantages, as the service provider will have opportunity to develop common caseframes usable over it's customer databases, permitting a better developed set of those caseframes than what might be possible for a database of a single customer. In that service model, a business or customer having a quantity of data to analyze provides a database containing free text to a service provider, that service provider maintaining at least an interpretation engine 506. The database might be located to a file, in which case the database file might be copied to a computer system of the service provider. Alternatively, the database might be a relational database located to an RDBMS 504. RDBMS might be maintained by the customer, in which case interpretation engine may access the RDBM through provided network connections, for example IP socket connections or other provided access references. Alternatively, the RDBMS might be maintained by the service provider, in which case the customer either loads the database to the RDBMS through network 520, or the service provider might load the database to the RDBMS through a provided file.

The interpretation process is conducted at suitable times, and a produced database or data warehouse may be provided to the customer by way of storage media or the network 520. Alternatively, a product database may be maintained by the service provider, with access being provided as necessary over network 520. Mining/visualization tool 518 may optionally connect to such a product database, wherever located, to perform analysis on the free text extractions. If tool 518 is not provided with filesystem access to a product database, it will be useful to provide access to it over network 520, particularly if the product database is stored to daemon 504 or another RDBMS accessible by network 520.

It should be understood that the operating systems need not be similar or identical, if data is passed between through common protocols. Additionally, RDMBS daemon 504 is only needed if data is stored or accessed in a relational database, which might not be necessary if databases are stored to files instead.

Methods disclosed herein may be practiced using programs or instructions executing on computer systems, for example having a CPU or other processing element and any number of input devices. Those programs or instructions might take the form of assembled or compiled instructions intended for native execution on a processing element, or might be instructions at a higher level interpretive language as desired. Those programs may be placed on media to form a computer program product, for example a CD-ROM, hard disk or flash card, which may provide for storage, execution and transfer of the programs. Those systems will include a unit for command and/or control of the operation of such a computing system, which might take the form of consoles or any number of input devices available presently or in the future. Those systems may optionally provide a means of monitoring the process, for example a monitor coupled with a video card and driven from an application graphical user interface. As suggested above, those systems may reference databases accessible locally to a processing element, or alternatively access databases across a network or other communications channel. The product of the processes might be stored to media, transferred to another network device, or remain internally in memory as desired according to the particular use of the product.

While computing systems functional to extract relational facts from free text records and optionally to integrate structured data records with interpretive free text information and the use thereof have been described and illustrated in conjunction with a number of specific configurations and methods, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1. A computer program product located to one or more storage media devices usable to perform integration of free text with coded data, said computer program product comprising instructions executable by a computer to perform the functions of:
accessing a database of structured data, the structured data comprising a set of data tuples wherein is contained information according to a coded data format;
accessing a source of free text, the free text being relatable to the data tuples of the structured data;
interpreting the free text to produce a set of construed data reflecting at least one relational fact conveyed in the free text, each construed datum relatable to a data tuple of the structured data; and
integrating the produced data with the data tuples of the structured data, said integrating producing integrated data.

2. A computer program product according to claim 1, wherein said accessing a source of free text accesses text contained within the database of structured data.

3. A computer program product according to claim 1, wherein said accessing a source of free text and said accessing a database of structured data access two separate data sources.

4. A computer program product according to claim 1, wherein said instructions are further executable to perform the function of applying caseframes while performing said interpreting the free text.

5. A computer program product according to claim 1, wherein said instructions are further executable to perform the function of producing a new database containing the integrated data produced by said integrating.

6. A computer program product according to claim 1, wherein said instructions are further executable to perform the function of inserting the produced data into the database of structured data while performing said integrating the produced data.

7. A computer program product according to claim 1, wherein said instructions are further executable to perform the function of creating a new database while performing said integrating the produced data.

8. A computer program product according to claim 7, wherein the instructions are further executable to produce a new relational database containing the integrated data produced by said integrating.

9. A computer program product according to claim 7, wherein the instructions are further executable to produce a file containing the integrated data produced by said integrating.

10. A computer program product according to claim 9, wherein the instructions are further executable to produce a file having a format selected from the group of XML, character separated values, spreadsheet formats and file-based database structures.

11. A computer system including a computer program product according to claim 1, further comprising:
a processing unit coupled to said one or more storage media devices, said processing unit being capable of executing said instructions; and
an execution command unit, whereby operation of said instructions and said processing unit may be commanded or controlled.

12. A computer program product according to claim 1, wherein said instructions are further executable to store an integrated database while performing said integrating the produced data.

13. A computer program product according to claim 1, wherein the integrated data produced by the performance of said integrating the produced data includes reference information to the original free text for construed data.

14. A computer program product according to claim 1, wherein said instructions are further executable to perform data mining on the integrated data.

15. A computer program product according to claim 1, wherein said instructions are further executable to render a visual representation all or a part of the integrated data.

16. A method of integrating free text and coded data, comprising the steps of:
accessing a database of structured data, the structured data comprising a set of data tuples wherein is contained information according to a coded data format;
accessing a source of free text, the free text being relatable to the data tuples of the structured data;
interpreting the free text to produce a set of construed data reflecting at least one relational fact conveyed in the free text, each construed datum relatable to a data tuple of the structured data; and
integrating the produced data with the data tuples of the structured data, said integrating producing integrated data.

17. A method according to claim 16, wherein said accessing a source of free text accesses text contained within the database of structured data.

18. A method according to claim 16, wherein said accessing a source of free text and said accessing a database of structured data access two separate data sources.

19. A method according to claim 16, further comprising the step of applying caseframes while performing said interpreting the free text.

20. A method according to claim 16, further comprising the step of producing a new database containing the integrated data produced by said integrating.

21. A method according to claim 16, further comprising the step of inserting the produced data into the database of structured data while performing said integrating the produced data.

22. A method according to claim 16, further comprising the step of creating a new database while performing said integrating the produced data.

23. A method according to claim 22, further comprising the step of producing a new relational database containing the integrated data produced by said integrating.

24. A method according to claim 22, further comprising the step of producing a file containing the integrated data produced by said integrating.

25. A method according to claim 24, wherein the produced file has a format selected from the group of XML, character separated values, spreadsheet formats and file-based database structures.

26. A method according to claim 16, further comprising the step of storing an integrated database while performing said integrating the produced data.

27. A method according to claim 16, wherein the integrated data produced by the performance of said integrating the produced data includes reference information to the original free text for construed data.

28. A method according to claim 16, further comprising the step of data mining the integrated data.

29. A method according to claim 16, further comprising the step of rendering a visual representation all or a part of the integrated data.
